(19) United States
(12) Patent Application Publication
(10) Pub. No.: US 2012/0074694 A1
(43) Pub. Date: Mar. 29, 2012

(54) SELF-ALIGNING SANITARY PIPE JOINTS AND RELATED SYSTEMS

(75) Inventor: Jeffrey C. Butte, Portland, OR (US)

(73) Assignee: HYGIENIC DESIGN GROUP LLC, Portland, OR (US)

(21) Appl. No.: 13/376,318

(22) PCT Filed: Jun. 8, 2010
(86) PCT No.: PCT/US10/37844

§ 371 Date: Dec. 5, 2011

Related U.S. Application Data
(60) Provisional application No. 61/185,037, filed on Jun. 8, 2009.

(51) Int. Cl. F16L 23/18; F16L 19/03

(52) U.S. Cl. 285/336; 277/614; 277/609; 277/314

(57) ABSTRACT

Systems for joining pipes used in the food processing and pharmaceutical industries are disclosed. For example, connections of fluid handling pipes and improved flange-type joints are disclosed. Some disclosed joints comprise a pair of flanges each defining a circumferentially extending channel recessed from an end face A radially extending end wall is positioned radially outward of the end face. Said end faces are retained in axially opposed relationship to each other such that a circumferential groove configured to receive a gasket is defined when the joint is assembled. The groove has a first portion open to the flow passage and a second portion extending radially outward from the first portion. A polymeric gasket can comprise a generally toroidal member axially compressed in the first portion of the groove when the joint is assembled. The radial end walls radially compress the gasket, and the gasket can expand radially outward.

### CROSS-REFERENCE TO RELATED APPLICATIONS

This application claims priority to and the benefit of U.S. provisional patent application No. 61/185,037, filed Jun. 8, 2009, by Jeffrey C. Butte and entitled SELF-ALIGNING SANITARY PIPE JOINT, which is hereby incorporated by reference herein for all purposes as if listed herein in its entirety.

### BACKGROUND

The present disclosure concerns sanitary fittings for pipes of the type employed in the food processing and pharmaceutical industries. More specifically, but not exclusively, the present disclosure concerns connections of fluid handling pipes and improved flange-type joints configured to, for example, retain such pipes in end-to-end relation.

Pipes can convey fluids or flowable food products and have been joined in end-to-end relation by connecting opposed flanges positioned on respective opposed pipe ends. To meet high force and rapid disassembly objectives, circumferentially extending, multi-section (e.g., hinged) clamps have been used to join such pipe ends to each other. Such clamps can include plural sections pivotally coupled to each other. The clamp sections can define respective recessed channels having internally opposed surfaces oriented at an angle relative to each other (e.g., the respective channels can have internal wedge surfaces) configured to urge against corresponding outer surfaces of opposed flanges. Flanges can define outwardly facing wedge surfaces on the exterior of the joint configured to be engaged by the wedge surfaces of an overlying clamp such that, as the clamp radially contracts, the respective angled surfaces axially compress the opposed surfaces of the flanges forming the joint (together with any gasket positioned therebetween). For example, since the respective surfaces are angled, the clamp urges against the flanges. As the clamp sections are radially drawn together (or the diameter of the clamp is otherwise reduced), the clamp urges the opposed flanges together. Such a clamp ring can be actuated by a thumb screw, configured to draw the plural clamp sections together, thereby reducing a diameter of the clamp ring.

Such joints are typically used in systems requiring frequent disassembly for cleaning, maintenance, and/or system changeover. In addition, pipes and flanges employed in the food processing and pharmaceutical industries are often suited for forming connecting joints in critical processing systems where fluid entrapment or retention within the system is undesirable, and, in some instances, must be avoided. In such systems, it is often difficult to completely eliminate regions that collect and/or retain process fluids and/or flowable food. Such regions are sometimes referred to herein as “recesses” or “pockets”. For example, process fluid or flowable food retained in such recesses or pockets can contaminate a fluid or food subsequently passing through the pipes and joint (e.g., when processing a second batch of the same fluid or food, or when processing a different fluid or food).

Problems posed by recesses and fluid trapping pockets are especially prevalent with respect to many pipe joints, which often include one or more resilient, elastomeric seals and packings. For example, a packed joint can be difficult to assemble and frequently forms undesired discontinuities between the connected sections (e.g., a step when moving axially from an interior surface of one pipe to an interior surface of an adjacent pipe, such as when the pipes are not in perfect axial alignment). Such steps and other deficiencies can arise, in part, from the use of a typical clamp mechanism that provides a compressive force, but does not provide axial alignment of the pipes. For example, opposing flanges can be misaligned, yet not so much that a conventional clamp cannot be assembled around them. In such an instance, the clamp can axially compress and retain the flanges in a radially misaligned position.

FIG. 1 illustrates a flange connection configuration of the prior art which suffers many deficiencies. In this prior art configuration, longitudinally extending ferrules 1, 2 configured to join respective pipe (or tube) ends 3, 4 are provided with respective radially outwardly extending flanges 5, 6. The respective ferrules 1, 2 can be butt welded to the respective pipe ends 3, 4 at a weld location 7. An adjustable clamp 8 overlies and engages the opposed flanges 5, 6. The clamp 8 can be adjusted by tightening a screw (not shown) which effectively reduces a radial dimension of the clamp 8 and, in combination with the angled surfaces 9, 9a of the clamp and flanges 10, 10a, thereby compresses an elastomeric gasket 11 positioned between the flanges.

In the configuration shown in FIG. 1, an outer angle of the flanges 5, 6 is 20 degrees from a plane oriented perpendicularly to a longitudinal axis of the pipe (e.g., an axial flow direction). The corresponding inner angle of the clamp 8 is 18.5 degrees. As the clamp 8 is drawn against the flanges, the inner surfaces 9, 9a of the clamp 8 contact and urge against the respective angled surfaces 10, 10a of the flanges 5, 6 thereby axially compressing the gasket 11 between the flanges 5, 6. The annular bead 12 aligns the flanges 5, 6 during assembly. When this pipe joint is compressed, a portion 13 of the gasket 11 can extend into the product zone 14 by as much as approximately 0.0625 inches, or more, which in turn can form an internal flow obstruction 13 and/or a region 15 that can collect, retain, etc., a process fluid or flowable food (e.g., a region 6 with an internal angle of about 90 degrees or less) which can lead to an unsanitary operating condition for subsequent uses. For example, piping systems in food processing plants are typically inclined by approximately 2 degrees to facilitate draining. Such an obstruction can trap liquid in a region 15 adjacent (e.g., behind) the gasket 11 (such a region 15 is sometimes referred to herein as a “pocket”), and the trapped liquid can contaminate a subsequent flow of fluid and/or flowable food. The obstruction also reduces a hydraulic diameter (e.g., an open flow cross-sectional area) and forms an orifice within the pipe that increases pressure head losses through the joint.

The extent of permissible intrusion of the gasket 11 into the product zone 14 is specified by the 3A Sanitary Standards, Inc. Pipeline Process Standard (605.04) which specifies a maximum 0.03125 inch deviation from internal flushness (e.g., gasket intrusion into the product zone, or recessed channel depth). Existing designs generally are incapable of meeting this specification.

For example, the pipe joint 50 depicted in FIG. 1 and just described permits the gasket 11 to be compressed by the clamp 8 to various degrees. Consequently, the gasket 11 can migrate into the product zone 14, which migration increases with increasing compression. Also, the gasket 11 expands during heating (e.g., during use with hot liquid or during steam sterilization) to a much greater extent than typical stainless steel alloys used to form the flanges 5, 6.

Such deformation of the gasket 11 under excessive compression and/or thermal expansion is depicted in FIG. 1A. Compression between the flanges 5, 6 causes an inner edge of the annular gasket 11 to expand inwardly and form a mushroom shaped bead 16, creating a pocket 15 between a passage wall 17 and the bead 16. An internal angle α between a line 18 tangent to the mushroom shaped bead 16 and the passage wall 17 can be less than 90 degrees.

Sanitary pipe joints, designed for pipe sizes of 1.0 inch or less, are commonly referred to as “mini” fittings. Mini fittings are typically found in high purity applications in pharmaceutical and biotechnology applications. In some instances, pipe joints across a variety of internal flow dimensions share a common flange size, allowing use of a same-size clamp 8 for each of the variety of internal flow dimensions, especially in pipes having an interior flow dimension of less than about 1 inch. In such pipe joints, an annular bead 12 is often positioned in the same radial position in the flange 5, 6, regardless of the corresponding interior flow dimension of the joint. For example, each of the variety of flanges defines a same-size, circumeferentially-extending, recessed channel, or groove, configured to receive a bead for a gasket. Gaskets for such flanges can physically be interchanged, since the grooves and beads share common dimensions, albeit without assurance that an open interior diameter of the gasket corresponds to an unobstructed interior diameter of the pipe. An annular gasket 11 having an open interior sized for a small interior flow dimension might not be suitable for use in a joint between pipes having a larger interior flow dimension, since at least a portion of the gasket could extend inwardly of the interior of the pipes. Conversely, an annular gasket having an open interior sized for a relatively larger interior flow dimension might not be suitable for use in a joint between pipes having a small interior flow dimension, since at least a portion of the joint between the pipes could define a recessed channel that otherwise would be occupied by a properly sized gasket.

Consequently, improperly sized gaskets can be used in a variety of pipe joints, including mini-fittings. Installing an improperly sized gasket 11 in a pipe joint can create an unsanitary pocket 15 (e.g., an internal bead 16, as shown in FIG. 1A) when a gasket with a relatively smaller interior diameter is installed in a larger pipe joint (FIG. 1A), or a recessed, circumferentially extending channel 19 can be formed within the joint (FIG. 1B), such as when a gasket 11a with an oversized opening (relative to an open interior dimension of the pipe) is used.

Improperly sized gaskets can suffer other deficiencies, as well. For example, an inwardly extending gasket can obstruct an internal pipe flow, increasing loss of pressure head through the joint and increasing pressure losses that must be overcome, as by a pump. Such inefficiencies can increase operating costs compared to more efficient assemblies.

FIG. 1C illustrates unsanitary pockets 15, 19a that can form when the flanges 5, 6 are improperly aligned. In FIG. 1C, misalignment is shown where the flanges 5, 6 are offset, resulting in unsanitary pockets 15, 19a both in a region adjacent the annular bead 12 and the corresponding recessed channel in the flange, and in the product zone 14. The gasket 11 is also shown deformed, which can exacerbate formation of such pockets 15, 19a.

One common sanitary pipe connection, described in U.S. Pat. No. 2,789,844, the entire disclosure of which is incorporated by reference herein, utilizes annular beads molded into an otherwise flat gasket in an attempt to align opposed flanges. Excessive compression applied to the joint will cause the gasket to extrude (or otherwise deform and enter) into an interior of the pipe (sometimes also referred to as a product zone), as shown for example in FIG. 1A. Because the portion 13 of the gasket extending into the product zone 14 is under less longitudinal compression than the portion between the flanges 5, 6, the portion extending into the product zone 14 can expand. Such expansion can form a region 15 on the interior of the joint bounded in part by the expanded gasket portion 16 and the interior of the passage wall 17. For example, the wall 17 and a generally axially extending line 18 tangent to the expanded gasket portion 16 can form an acute angle α. This results in an unsanitary condition because process fluids and/or flowable food can be trapped in regions 15 having internal angles of less than 90 degrees with no radius (e.g., due to surface tension).

Pipeline process standard No. 605-04, published by 3A Sanitary Standards; Inc., specifies a maximum 1/32 inch minimum deviation of an elastomeric gasket into the product zone 14 of a process pipe. A surface discontinuity of 1/32 inch or less is considered “substantially flush” according to 3A Sanitary Standards, Inc., which is a requirement under the Sanitary Fittings standard 63-03.

One approach of ameliorating such deficiencies is disclosed in U.S. Pat. No. 6,039,319, the entire disclosure of which is incorporated by reference herein. The '319 patent discloses a reduced gasket size relative to an open volume of the gasket-receiving channel, which provides a region into which an axially compressed gasket can expand. The flanges disclosed in the '319 patent are brought together in physical contact radially outward of the gasket. Such metal-to-metal contact limits compression of the gasket. The '319 patent discloses a flat sealing surface defined by the flange and configured to interact with the gasket, which can allow a portion of the gasket to migrate into the product zone under various temperature or vacuum conditions. Also, verifying that a gasket is present in the joint disclosed in the '319 patent is not possible by visual inspection because contact between the opposed flanges is positioned radially outward of the gasket.

Another improvement upon the disclosure of the U.S. Pat. No. 2,789,844 is shown in U.S. Pat. No. 6,857,638, the entire disclosure of which is incorporated by reference herein. The '638 patent discloses a gasket having an elastomeric O-ring portion and an incompressible ring member. The gasket is configured for establishing a seal between flanges of sanitary pipe fittings. The O-ring portion has a substantially flat cross-section to limit compression of the O-ring. The '638 patent design limits compression of a gasket, but does not correct or ameliorate other deficiencies noted above with regard to sanitary pipe joints.

Therefore, there remains a need in the art of pipe fittings for use in the food and/or pharmaceutical industries for a joint construction which is easy to assemble. There also remains the need with the field for a joint construction that does not form pockets, recesses, or other undesirable discontinuities which can trap, collector or retain process fluids, flowable food, or both. The present disclosure addresses these and other needs.

### SUMMARY

Innovations disclosed herein can be used in a wide variety of applications, including sanitary fittings for pipes of the type employed in the food processing and pharmaceutical industries.

For example, some presently disclosed innovations concern methods of forming lengths of pipe for assembly together to form fluid flow conduits. Such methods can include the acts of providing a pipe having a first inner diameter and a central longitudinal axis, providing a ferrule which has an annular first end, having an inner diameter equal to the pipe inner diameter and having a second end formed into a flange adapted to form a flange coupling when abutted against and connected to another similar or identical flange. The first end of each ferrule is welded to an end of a pipe, wherein the end face of the flange assumes an orientation wherein the end face is substantially normal to the central longitudinal axis.

A clamped flange pipe or tube fitting assembly can a resilient seal ring compressed by a clamp, whereby the shape of the inner surfaces of clamp provides for correct alignment of the flanges and fixed compression of the gasket. In some embodiments, correct alignment and improved ease of assembly is provided by increasing the internal angled surfaces of the clamp from 18.5 to approximately 37 degrees. Fixed compression of the gasket can be provided by seating the flange ends into mating grooves in the clamp at the completion of assembly.

Sealing gaskets for insertion into a circumferentially continuous groove of a flange joint for joining axially aligned tube ends are disclosed. The flange joint has axially opposed flanges at the tube ends forming a groove therebetween when the joint is assembled. The groove is formed by axially opposed seal faces and radial end faces of the flanges. The groove can include a circular O-ring groove first portion that is open to an interior flow passage of the tubes and a second groove second portion that extends radially outward from the groove first portion. The gasket has a gasket first portion that seals the circular groove first portion and a flat gasket second portion that extends from the circular gasket section. A space formed between the terminus of the gasket second section and the terminus of the center ridge on the clamp forms an expansion space in the joint when the joint is assembled. The expansion space is vented to atmosphere. Some disclosed clamps include sections that are hinged and/or bolted together.

Some disclosed innovations include a tube joint assembly that is configured to eliminate or greatly reduce gasket extrusion, reduce flow restriction, reduce contamination, reduce fluid retention, and/or provide improved alignment during assembly. For example, some tube joint assemblies include a pair of cylindrical tube ends in axially aligned end-to-end relationship. Each tube end can have a cylindrical interior surface of substantially the same diameter in aligned relationship with the cylindrical interior surface of the opposed tube end. Connecting flanges can extend radially outward of each tube end with axially opposed faces defining a circumferentially continuous packing groove including a first arced-shaped surface, and an axially wide portion defined by a semi-circular groove. A second axially narrow portion of the groove is positioned radially outward of the first portion and has a radial outer face radially overlying and aligned with the first semi-circular portion. A soft material gasket is positioned in the packing groove. One disclosed gasket configuration has a toroidal portion of the type commonly known in the art as an O-ring that is sized and dimensioned to completely fill the first semi-circular portion of the packing groove and engage the axially opposed sealing faces with substantial sealing pressure. A second portion of the gasket can have a unitary construction with the first portion, and can be sized and dimensioned to extend into the second, axially narrow portion of the packing groove. The second portion can have an inner radial dimension that forms an interference fit with the tube ends for ease of assembly and/or sufficient mass to hold the tube ends in a desired aligned relation during assembly of the joint. Such structural features can contribute to improved alignment of the components in the assembled fluid system, thereby improving the ease of assembly.

The second portion of the gasket can have a radial dimension sufficient to extend radially across the second portion of the packing groove and into compressive engagement with the radial outer face thereof when the joint is completed. The axial extent of the packing groove can be sufficiently large to define an expansion space into which the gasket can expand, such as when the gasket is subjected to an increase in temperature. The expansion space can reduce and/or eliminate radially inward extrusion of the gasket beyond the cylindrical interior surfaces of the tube ends.

In some instances, rigid members are defined by surface portions of the opposed faces of the connecting flanges. The clamp can align the flanges axially and prevent movement of the flanges toward one another beyond a predetermined minimum point.

Methods for forming lengths of pipe for assembly together to form fluid flow conduits are also disclosed. Such methods can include (a) providing (i) a pipe having a first inner diameter and a central longitudinal axis, (ii) a plurality of ferrules having an annular first end, an inner diameter substantially equal to the first inner diameter and (iii) a second end formed into a flange substantially adapted to form a flange coupling when abutted against and connected to another ferrule having a flange.

For example, such fluid flow conduits can have the first end of each ferrule welded to an end of a pipe, whereby the end face of the flange assumes an orientation wherein the end face is substantially normal to the central longitudinal axis. Further still, a clamped flange pipe or tube fitting assembly can further include a resilient seal ring compressed by a clamp, whereby the angle of the inner surfaces of clamp, being substantially greater than the respective angle of the flanges, during compression, can correct initial flange misalignment and provide for correct axial alignment of the flanges as well as fixed gasket compression by guiding the ferrule ends during compression and seating the flange ends into respective mating grooves in said clamp at the completion of compression. There is further disclosed a sealing gasket for insertion into a circumferentially continuous groove of a flange joint for joining axially aligned tube ends, the flange joint being of the type having axially opposed flanges at the tube ends to form a groove there between when the joint is assembled, the groove being formed by axially opposed seal faces and radial end faces of the flanges, wherein the groove comprises a circular O-ring groove first portion that is open to an interior flow passage of the tubes and a second groove second portion that extends radially outward from the groove first portion, wherein the gasket comprises a gasket first portion that seals the circular groove first portion and a flat gasket second portion that extends from the circular gasket section. A space formed between the terminus of the gasket second section and the terminus of the center ridge on the clamp forms an expansion space in the when the joint is assembled that is vented to atmosphere at the hinged and bolt portions of the clamp.

A flange joint and gasket for joining and sealing tube or pipe ends that define an axial flow passage therethrough are disclosed. The joint includes a first annular flange and a second annular flange, each of said flanges being at a respective one of the tube ends. Each of said flanges define a respective end face, a circumferentially extending channel recessed from the end face, and a radially extending end wall positioned radially outward of the end face. Said end faces are in axially opposed relationship to each other such that a circumferential groove configured to receive a gasket is defined when the joint is assembled. Said groove has a first portion open to the flow passage of the tubes and has a second portion that extends radially outward from said groove first portion. Said groove second portion is radially bounded by said radially extending end walls. The joint also includes a polymeric gasket configured to sealingly engage the groove when the joint is assembled for preventing a loss of fluid from the flow passage of the tubes. Said gasket has a gasket first portion configured to sealingly engage said groove first portion and has a gasket second portion that extends from said gasket first portion and into said groove second portion. Said gasket first portion includes a generally toroidal member that is axially compressed when the joint is assembled and said gasket second portion is axially compressed when the joint is assembled and engages with said radial end walls to produce a radial compression of said gasket. Said gasket second portion has a volume that is less than a volume of said groove first portion to enable radially outward expansion of the gasket when the joint is assembled.

Some disclosed joints also include a clamp defining longitudinally spaced and circumferentially extending recessed regions separated by a flange-engaging ridge. The clamp can overlie the pair of flanges such that at least a portion of the flange-engaging ridge is positioned radially outward of the gasket. A radially outermost portion of the gasket can be radially spaced from the flange-engaging ridge of the clamp to define an expansion space configured to permit radially outward expansion of the gasket.

Said radial compression can opposes radial pressure from fluid in the flow passage to prevent radial displacement of said gasket into the product zone of the pipe. The radial compression can be limited by seating the flanges in corresponding mating portions of the recessed regions of the clamp such that the flange-engaging ridge is positioned between the flanges.

The clamp can have angled surfaces that are oriented at respective angles greater than an angle of the corresponding flanges and align with angled surfaces of the respective flanges to urge the flange ends together as said clamp radially compresses the flanges. Said gasket second portion can engage said radial end walls and allow for radial expansion of the gasket. A region adjacent the gasket second portion and the gasket first portion can form a secondary seal against a radially oriented surface.

Said gasket second portion can have an outer edge face in radial alignment with said gasket first portion. Said gasket second portion can be axially symmetric about a radial line that is common to said gasket first and second portions.

Said engagement between said gasket second portion and said radial end walls can provide a barrier to prevent ingress of matter into said groove from outside the assembly.

Said flanges can define radially extending clamp-engaging portions positioned radially outward of said radial end walls. A radial distal portion of said gasket second portion can include a flat gasket that engages said radial end walls when the joint is assembled. The flat gasket can terminate adjacent the clamp-engaging portions of said flanges.

Said gasket second portion can have a unitary construction with said gasket first portion. Said gasket second portion can be axially wider than said gasket first portion with a shoulder formed at an interface of said gasket first and second portions. Said interface can permit said gasket to be centered and retained on one of said flanges during assembly of the joint. Said gasket second portion when uncompressed can have an axial dimension that is less than said axial dimension of said groove second portion. Said gasket second portion can comprise any suitably stiff material (e.g., a plastic, a metal alloy, such as, for example, an alloy of steel) and serve to stiffen the gasket and maintain a desired alignment of the gasket relative to the flanges during assembly of the joint. Said gasket can have a skeleton key-shaped cross-section.

Said gasket first portion can include an O-ring with an inner annular surface. Said O-ring annular surface can have a first diameter before the gasket is positioned on one of said flanges and a second diameter that is greater than said first diameter after the gasket is positioned on one of said flanges and before the gasket is compressed.

Said radial end walls can be formed by rigid radial outer extensions of said flanges that engage independently into mating grooves in the clamp when the joint is assembled to prohibit axial movement of the flanges. Said engagement of flange ends into mating grooves in the clamp when the joint is assembled can provide a limited, or a fixed, compression of the gasket.

Said gasket first portion can be axially compressed in the range of about 10% to about 20% strain when the joint is assembled. Said gasket second portion can be axially compressed in the range of about 5% to about 15% strain.

Disclosed gaskets can be formed of any suitable materials. Some gaskets are formed entirely of an elastomeric material. Some gaskets comprise a combination of a stiff material and an elastomer.

Sealing gaskets for insertion into a circumferentially continuous groove of a flange joint for joining axially aligned tube ends are disclosed. Some disclosed gaskets define a gasket first portion for sealing a groove first portion and a gasket second portion that extends from said gasket first portion and into a groove second portion. Said gasket first portion can include an O-ring that is axially compressed when the joint is assembled. The O-ring when under compression in the assembled joint can be radially displaced to form a substantially flush seal that is contiguous with interior surfaces of the tubes. The O-ring and the interior surfaces of the tubes can define an internal angle of greater than 90 degrees within the product-contact zone. Radial compression can oppose radial pressure from fluid in the flow passage to prevent radial displacement of said gasket. Said radial compression can increase an effective hoop strength of said gasket.

The groove first portion can be axially narrower than the groove second portion to form a shoulder at the radial interface thereof. Said gasket can be sized to have an interference fit with said shoulder to retain the gasket in position when the joint is assembled. Said gasket second portion when uncompressed can have an axial dimension that is less than an axial dimension of said groove second portion and has sufficient mass to stiffen the gasket and maintain a desired alignment of the gasket relative to the flanges during assembly of the joint.

Methods for sealing flange joints between an opposed pair of flanges configured to join axially aligned tube ends and forming a groove therebetween with the groove being defined by axially opposed seal faces and a radial end face are disclosed. For example, a polymeric gasket can be positioned in a first and second portion of the groove between axially opposed seal faces of the flanges with said groove second portion being radially bounded by said radial end walls. The gasket can be compressed axially when the joint is assembled to displace a portion of the gasket that radially engages the radial end face. An O-ring of said gasket can be axially compressed in the groove first portion so that said O-ring is radially displaced to form a seal that is substantially flush with interior surfaces of the tubes. The gasket can be axially compressed when the joint is assembled.

An interference fit between the gasket and the flanges can be used to retain the gasket in a desired centered position during assembly of the joint. A sufficient mass can be provided to the gasket to maintain a desired alignment of the gasket with respect to the flanges during assembly of the joint.

The inventor of the presently disclosed innovations discovered that materials used for such gaskets undergo an extrusion-like expansion due to an initial configuration of a joint, due to increased temperature, or a combination thereof. By providing expansion space at a location disposed radially outward of the inner O-ring sealing portion of the gasket, a significant reduction of gasket expansion into the flow path can be achieved. Moreover, the compressive engagement forms a secondary seal radially outward of the primary O-ring seal.

The inventor also discovered that improper alignment of pipe joints can arise, in part, because there is no metal to metal contact between opposed ferrules and because a clamp 8 (FIG. 1) allows such misalignment. Such misalignment can also arise from the pipes being out of position due to poor workmanship or temperature variations, or due to damage to the flanges 5, 6 (FIG. 1), from improper handling or excessive heat applied during welding procedures that can warp the flanges.

A further problem occurs in that when a ferrule is welded to the pipe, there is a tendency for the pipe to shrink slightly in the vicinity of the weld. This causes a small amount of tilting of the faces of the flange away from the central axis so that they will not be able to come into flush abutment with each other. Excessive heat during welding operations can also cause the ferrules to warp, which can result in improper gasket seating, ferrule misalignment and/or the creation of unsanitary pockets within the pipe joint, as shown for example in FIG. 1C.

As indicated above, pipe fitting and gasket assemblies that reduce the extent of extrusion of the gasket into a fluid flow path, among other innovations, are disclosed. A smooth, substantially continuous inner wall surface is thereby maintained, reducing fluid retention, flow restriction and/or system contamination during subsequent uses. Also, improved alignment of the components of the joint assembly is provided using substantially identical pairs of opposing flanges. Such joints are easy to assemble, in part because, at least in some embodiments, there is no metal contact between the opposing flanges. An increased inner angle of the clamp of approximately 37 degrees (as compared to about 18.5 degrees in the prior art) provides surprisingly improved alignment during assembly and use. In addition, hard seating of the outermost portions of the flanges (also referred to sometimes as “flange ends into mating grooves in the clamp improves alignment compared to heretofore known joints.

The foregoing and other features and advantages will become more apparent from the following detailed description, which proceeds with reference to the accompanying drawings.

### BRIEF DESCRIPTION OF THE DRAWINGS

FIG. 1 shows a fragmentary cross-sectional view of a flange type pipe connection in the prior art.

FIG. 1A is a fragmentary cross-sectional view of the connection shown in FIG. 1 subjected to over-compression.

FIG. 1B shows a fragmentary cross-sectional view of the connection depicted in FIG. 1, into which an improperly sized sealing gasket has been inserted (e.g., an internal opening in the gasket is smaller than the corresponding flow cross-section of the pipe.

FIG. 1C shows a fragmentary cross-sectional view of a connection of the type illustrated in FIG. 1 in which the flanges axially misaligned, such as can occur from improper handling when disassembled, warping of the flange during welding or exposure to excessive torque during installation in a piping system.

FIG. 2A shows a fragmentary cross-sectional view of one embodiment of a self-aligning flange type pipe connection as disclosed herein.

FIG. 2B shows a detailed view of a portion of a flange shown in FIG. 2A.

FIG. 3 shows a fragmentary cross-sectional view of the sealing gasket used in the connection shown in FIGS. 2A and 2B.

FIG. 4 shows a fragmentary cross-sectional view of an alternative embodiment of a self-aligning flange type pipe connection as disclosed herein.

### DETAILED DESCRIPTION

The following describes various principles related to sanitary pipe joint systems by way of reference to exemplary embodiments. One or more of the disclosed principles can be incorporated in various system configurations to achieve various sanitary pipe joint characteristics. Systems relating to one particular application are merely examples of disclosed innovative pipe joint systems and are described below to illustrate aspects of the various principles disclosed herein. Embodiments of the innovations disclosed herein may be used in other sanitary applications without deviating from the principles disclosed herein.

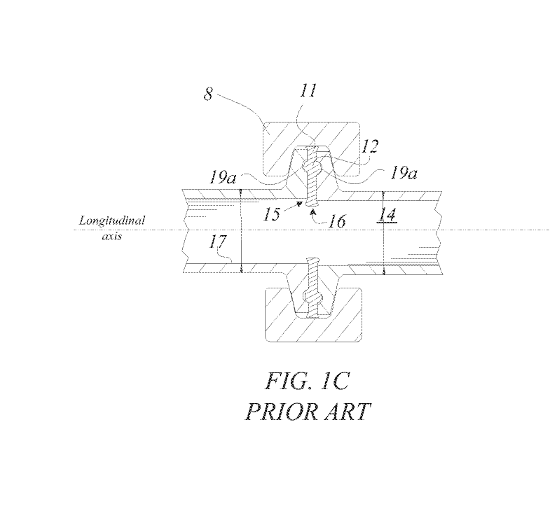

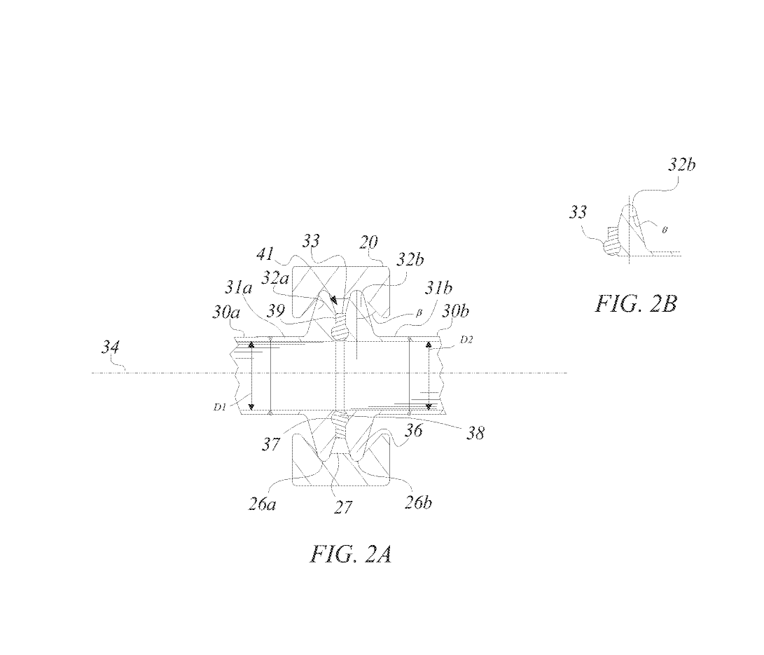

FIG. 2 shows, as but one example of disclosed innovations, a pair of axially aligned, cylindrical pipe or tube ends 30a, 30b having respective ferrules 31a, 31b welded thereto. The ferrules 31a, 31b define radially outwardly extending flanges 32a, 32b. The flanges 32a, 32b are joined in end-to-end relation with a gasket 33 positioned therebetween, so as to form a sealed flange-type joint assembly 50. The illustrated flanges 32a, 32b are detachably affixed to each other by a circumferentially extending, radially compressing clamp 20 which in some instances is a two-piece bolted clamp. In other instances, the clamp 20 is configured to pivot open and to be retained in a closed position with a clasp (not shown) in a known manner.

Each tube end 30a, 30b can have a respective substantially uniform open interior 14 having, for example, an interior diameter D1, D2. In some instances, the diameters D1, D2 have the same dimension. In FIG. 2, the tube ends 30a, 30b are in axial alignment (i.e., a longitudinal axis 34 defined by the tube end 30a is coextensive with a longitudinal axis of the tube end 30b).

Each ferrule member 31a, 31b shown in FIG. 2 has an annular portion 35a, 35b portion configured to be welded or otherwise joined (e.g., by brazing, soldering or other metal joining technique) to a respective tube end 30a, 30b, forming a unitary construction having a tube portion and a flanged portion. In another embodiment, the flanges 32a, 32b are integrally formed on the respective tube ends 30a, 30b.

A radially outwardly extending flange 32a, 32b extends from each ferrule portion 31a, 31b and defines a clamp engagement region 36 and a gasket receiving region 37. Each of the respective ferrule portions of the flange members 21, 26 is attached to a respective end of each of the tubes. The flanges allow the tube ends to be detachably affixed to each other, as by applying an adjustable clamp ring 24 in a circumferentially overlying engagement with the radially outwardly extending flanges. Such a removable engagement between the clamp ring 24 and the flanges is schematically illustrated in FIG. 2.

Each of the flanges 32a, 32b defines a sealing end face 39 that can lie in a common plane oriented perpendicularly relative to the center (i.e., longitudinal) axis 34. Each of the end faces 39 defines a recessed, annular channel 37 generally centered about the longitudinal axis 34 and configured to receive a gasket 33. When in opposing, coaxial alignment, the end faces 39 of the respective flanges 32a, 32b together define a circumferentially extending, continuous recess or groove 30 configured to receive a seal-forming packing, such as, for example, a gasket 33.

The packing receiving groove has a generally annularly shaped cross-section (for a cross-section taken transverse to the longitudinal axis 34) having an open interior dimensioned to correspond to a interior flow dimension D1, D2 of the tube ends 31a, 31b. As indicated in FIG. 2, the groove can have a generally toroidal region formed by the recessed channel 37 and positioned adjacent the interior flow opening 14. The toroidal region can receive a corresponding bead 38 of an O-ring. A portion of the receiving groove defined by the sealing end face 39 can define a generally flat, cylindrical portion extending radially outward of the toroidal region formed by the recess 37.

When the flanges 32a, 32b are clamped into an opposing, end-to-end relationship as shown in FIG. 2, the inner, toroidal portion portion of the groove can open inwardly toward the interior 14 of the central flow passage, in some instances.

As noted above, the groove can further include a second, axially narrower portion extending radially outward of the toroidal portion. The narrower portion can extend circumferentially of the toroidal portion, such as through 360-degrees. The narrower portion can have a thickness measuring approximately one-third of the cross-sectional diameter of the toroidal portion.

Positioned within the groove is a gasket 33 formed from a suitably pliable material that will form an effective seal when compressed between the flanges 32a, 32b. Examples of suitably pliable materials for the gasket 33 include, but are not limited to ethylene propylenes, fluorocarbons, silicone rubbers, nitrites, neoprenes, polyethylene and tetrafluoroethylenes, the specific selection being based on a particular intended application.

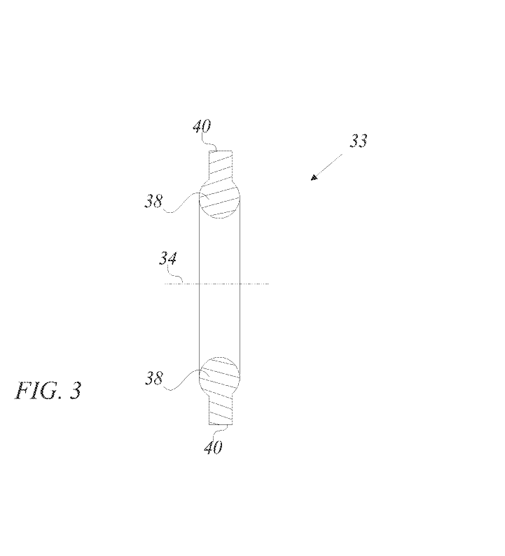

The gasket 33 can have a cross-section as illustrated in FIG. 3. The shape of the gasket 33 can have different configurations and appearances. As shown in FIGS. 2 and 3, the gasket 33 can be ring shaped and include a radially inward portion 38 having a generally circular cross section. The toroidal portion 38 can sealingly engage the walls of the recessed channel 37 and form a primary seal. A radially extending outer portion 40 can have a rectangular cross section (e.g., can be a generally annular disc) and sealingly engage the sealing end face 39, so as to form a secondary seal. A cross-sectional diameter of the inward portion 38 can be selected relative to a cross-sectional width of the outward portion 40 so that in the assembly of the joint 50, the gasket 33 will be engaged by the corresponding regions 37, 39 of the flanges 32a, 32b.

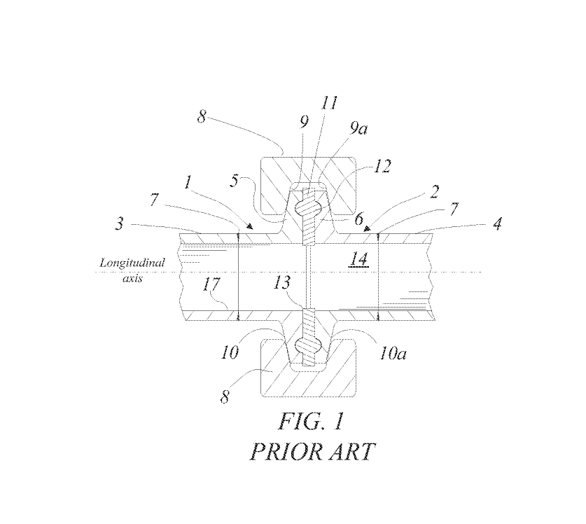

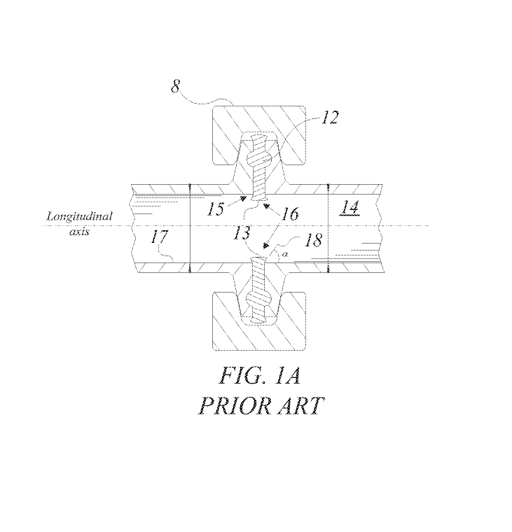

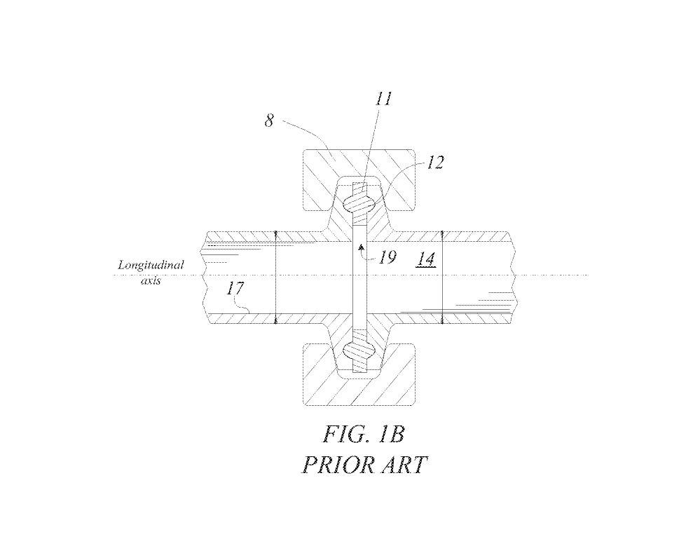

When a corresponding gasket member is positioned within the groove and the flanges 32a, 32b are clasped (or otherwise retained) together, the gasket member 33 can fill, and thereby seal, such a groove. Even to the extent that any part of the toroidal portion 38 of the gasket 33 extends radially inwardly of the tube wall 17 (e.g., into the product zone 14), an obtuse (i.e., greater than 90 degrees) angle forms between the wall 17 and a line tangent to the gasket 33 at the point of contact between the gasket and the wall. Thus, a region adjacent an inwardly extending portion of the gasket is much less likely to form a pocket or other region 15 (FIG. 1A) that collects and/or retains a process fluid or flowable food. Such a gasket and flange configuration as shown in FIGS. 2 and 3 provides a much lower likelihood of contamination of subsequent flows of fluids or flowable foods through the joint.

As is noted in the European Hygenic Engineering and Design Group (EHEDG) Guideline 16 (Hygenic Pipe Couplings, 1997), the thermal expansion of elastomers may be as much as 15-fold greater (for silicone rubber) that that of stainless steel alloys. In the configuration shown in FIGS. 2 and 3, gasket expansion is directed to an air space 41 between the gasket and the clamp by the shape of the gasket. For example, the shape of the inner toroidal portion 38 of the gasket limits the gasket's ability to expand radially inward into the product zone 14. The air space 41 is vented to the atmosphere at one or more hinge and/or bolt portions of the clamp 20. Since elevated temperatures that accompany gasket expansion is typically accompanied by elevated internal pipe pressures, especially if steam sterilization is employed, a differential pressure is created that encourages the gasket 33 to expand radially outward towards the air space 41 rather than radially inward into the product zone 14.

A longitudinal dimension of the packing groove, as well as alignment of the flanges 32a, 32b with respect to the center axis 34 can be provided by the clamp 20. For example, each of the radially extending flange portions 32a, 32b can each define a clamp engaging region 36 positioned radially outward of the gasket receiving region 37, the end face 39, or both. The clamp engaging region can define a surface that is recessed, or angled away, from the sealing face region 39, such that when a corresponding flange 32a, 32b is positioned in an opposing relationship, the respective clamp engaging regions 36 define a radially recessed channel (or air space) 41 extending circumferentially of the flanges 32a, 32b.

A clamp 20 configured to circumferentially overlie such a pair of flanges 32a, 32b can define a corresponding channel 26a, 26b configured to matingly engage each respective clamp engaging region 36 of the flanges 32a, 32b. Such a mating engagement can sufficiently longitudinally compress a gasket 33 positioned within the groove as to seal the joint 50 formed between the flanges. The mating engagement can also align the flanges.

For example, the clamp 20 can define an internal, circumferentially extending and radially recessed groove into which an opposed pair of flanges 32a, 32b can be seated. The groove can have first and second recessed regions 26a, 26b longitudinally spaced from each other. The first and second recessed regions 26a, 26b can be separated by a circumferentially extending flange-engaging ridge 27. Longitudinally outward of the first and the second recessed regions 26a, 26b, the clamp 20 can define respective first and second clamp ridges 28a, 28b. When such a clamp 20 overlies a pair of corresponding flanges 32a, 32b having respective clamp engaging regions 36, the flange-engaging ridge 27 can be positioned between the respective clamp engaging regions. The first and second clamp ridges 28a, 28b can be positioned longitudinally outward of, and thereby longitudinally retain the clamp engaging regions of the flanges. When the clamp 20 is radially tightened, the clamp engaging portion of each flange 32a, 32b rides along a corresponding one of the first and second clamp ridges 28a, 28b, urging the flanges 32a, 32b toward each other longitudinally and thereby compressing the gasket 33. The flange-engaging ridge 27 can engage the respective flanges 32a, 32b, and limit the extent to which the flanges can approach each other longitudinally in response to urging from the clamp ridges 28a, 28b, thereby limiting the extent to which the gasket 33 can be compressed longitudinally.

Such engagement of the first and second clamp ridges 28a, 28b and the flange-engaging ridge 27 with the clamp engaging portions 36 of the flanges 32a, 32b provides improved axial alignment of the respective flanges (and the corresponding tubes). An internal angle β of the clamp ridges 28a, 28b relative to a plane oriented perpendicularly to the longitudinal axis 34 can measure approximately 37 degrees, such as between about 32 degrees and about 42 degrees, which is significantly greater than the approximately 20 degree outer angle θ the respective flanges 32a, 32b. Such a difference in angles β, θ also provides improved alignment between the flanges as compared to conventional flange and clamp assemblies.

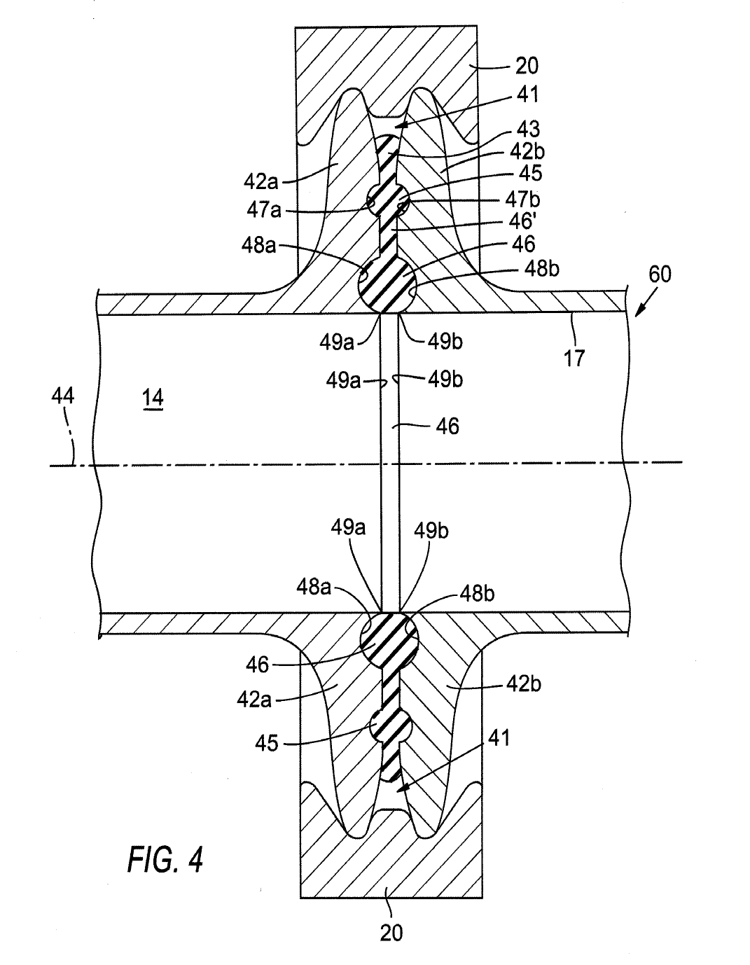

Other joint configurations are also possible. For example, FIG. 4 shows an assembly 60 having an overlying clamp 20, as described above and opposed flanges 42a, 42b. A gasket 43 is positioned between the opposed flanges 42a, 42b. The gasket 43 defines a generally toroidal inner head 46 and a concentric outer bead 45 outwardly spaced from the inner bead. The outer bead 45 can have a generally circular cross-sectional shape, as shown in FIG. 4, or another shape. An axial (relative to the longitudinal axis 44 of the flow passage 14) dimension of the outer bead 45 can be less than a corresponding axial dimension of the inner bead 46. A web 46 of gasket material can span the distance between the beads 45, 46 and can sealingly engage a corresponding surface of each flange 42a, 42b. A portion of the gasket 43 can extend radially outward of the outer bead 45 and into the air space 41. Each of the flanges 42a, 42b can define a respective pair of recessed channels 47a, 48a and 47b, 48b corresponding to the axially extending portions of the inner and the outer beads 45, 46.

The pair of beads 45, 46 provides improved alignment and retention of the gasket 43 in the recessed channels 47a, 48a and/or 47b, 48b during assembly of the joint, as compared to a gasket with only a single bead. For example, the gasket 43 can be seated in one pair of channels in a corresponding flange, and the other flange can be brought into opposed axial alignment therewith, in a manner as described above. During such assembly, the second, outer bead 45 helps keep the gasket 43 from buckling or otherwise unseating from the inner recess 48a, 48b as could occur during assembly if the flanges 42a, 42b are moved transversely relative to each during assembly. As a result of such a movement, for example, an edge 49a, 49b of the recess 48a, 48b could engage (e.g., “catch”) and unseat the inner bead 46 from the recess 48a, 48b in the absence of, for example, the stiffening effect of the outer bead 45. If the clamp 20 engages and urges the flanges 42a, 42b together in such an instance, an unsanitary pocket and/or gasket bulge (not shown) could form adjacent one or both edges 49a, 49b.

Although such pockets and/or bulges are unlikely using a gasket configured as shown in FIG. 3 and described above, the likelihood of such pockets and/or bulges is further reduced using a gasket 43 configured as shown in FIG. 4. Accordingly, a gasket and flange configuration as shown in FIG. 4 provides a low likelihood of contamination of subsequent flows of fluids or flowable foods through the joint 60.

With systems disclosed herein, it is possible in many embodiments to provide a sanitary joint between pipes (or tubes). Although principles have been described by way of reference to exemplary embodiments having circular cross-sections, other cross-sectional shapes are possible without deviating from the principles disclosed herein. By way of example and not limitation, such alternative cross-sectional shapes include square, rectangular, oval, ellipsoid and arbitrary shapes. References to a “diameter” (or radius) of an interior flow opening can be understood as a reference to a “hydraulic diameter” when considered in the context of a flow cross-sectional shape of other than a circle, and shall be so understood when the context requires.

This disclosure makes reference to the accompanying drawings which form a part hereof, wherein like numerals designate like parts throughout. The drawings illustrate specific embodiments, but other embodiments may be formed and structural changes may be made without departing from the intended scope of this disclosure. Directions and references (e.g., up, down, top, bottom, left, right, rearward, forward, etc.) may be used to facilitate discussion of the drawings but are not intended to be limiting. For example, certain terms may be used such as “up,” “down,”, “upper,” “lower,” “horizontal,” “vertical,” “left,” “right,” and the like. These terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same surface and the object remains the same. As used herein, “and/or” means “and” as well as “and” and “or.”

Accordingly, this detailed description shall not be construed in a limiting sense, and following a review of this disclosure, those of ordinary skill in the art will appreciate the wide variety of imaging systems that can be devised and constructed using the various concepts described herein. Moreover, those of ordinary skill in the art will appreciate that the exemplary embodiments disclosed herein can be adapted to various configurations without departing from the disclosed concepts. Thus, in view of the many possible embodiments to which the disclosed principles can be applied, it should be recognized that the above-described embodiments are only examples and should not be taken as limiting in scope. I therefore currently claim as my invention all that comes within the scope and spirit of the following claims.

I currently claim:

1. A flange joint and gasket for joining and sealing tube or pipe ends that define an axial flow passage there through, comprising:
a first annular flange and a second annular flange, each of said flanges being at a respective one of the tube ends; each of said flanges defining a respective end face, a circumferentially extending channel recessed from the end face, and a radially extending end wall positioned radially outward of the end face, said end faces in axially opposed relationship to each other such that a circumferential groove configured to receive a gasket is defined when the joint is assembled; said groove having a first portion open to the flow passage of the tubes and having a second portion that extends radially outward from said groove first portion, said groove second portion being radially bounded by said radially extending end walls; and
a polymeric gasket configured to sealingly engage the groove when the joint is assembled for preventing a loss of fluid from the flow passage of the tubes, said gasket having a gasket first portion configured to sealingly engage said groove first portion and having a gasket second portion that extends from said gasket first portion and into said groove second portion; said gasket first portion comprising a generally toroidal member that is axially compressed when the joint is assembled and said gasket second portion being axially compressed when the joint is assembled and engaging with said radial end walls to produce a radial compression of said gasket; said gasket second portion having a volume that is less than a volume of said groove first portion to enable radially outward expansion of the gasket when the joint is assembled.

2. The assembly of claim 1, further comprising a clamp defining longitudinally spaced and circumferentially extending recessed regions separated by a flange-engaging ridge, the clamp overlying the pair of flanges such that at least a portion of the flange-engaging ridge is positioned radially outward of the gasket.

3. The assembly of claim 1 wherein said radial compression opposes radial pressure from fluid in the flow passage to prevent radial displacement of said gasket into the product zone of the pipe.

4. The assembly of claim 2 wherein the radial compression is limited by seating the flanges in corresponding mating portions of the recessed regions of the clamp such that the flange-engaging region is positioned between the flanges.

5. The assembly of claim 4 wherein the clamp has angled surfaces that are oriented at respective angles greater than an angle of the corresponding flanges and align with angled surfaces of the respective flanges to urge the flange ends together as said clamp radially compresses the flanges.

6. The assembly of claim 5 wherein said gasket second portion engaging said radial end walls allows for radial expansion of the gasket and an region adjacent the gasket second portion and the gasket first portion forms a secondary seal against a radially oriented surface.

7. The assembly of claim 1 wherein said gasket second portion has an outer edge face in radially alignment with said gasket first portion.

8. The assembly of claim 1 wherein said gasket second portion is axially symmetric about a radial line that is common to said gasket first and second portions.

9. The assembly of claim 1 wherein said engagement between said gasket second portion and said radial end walls provides a barrier to prevent ingress of matter into said groove from outside the assembly.

10. The assembly of claim 1 wherein said flanges define radially extending clamp-engaging portions positioned radially outward of said radial end walls, and wherein a radial distal portion of said gasket second portion comprises a flat gasket that engages said radial end walls when the joint is assembled and terminates adjacent the clamp-engaging portions of said flanges.

11. The assembly of claim 2 wherein a radially outermost portion of the gasket is radially spaced from the flange-engaging ridge of the clamp to define an expansion space configured to permit radially outward expansion of the gasket.

12. The assembly of claim 1 wherein said gasket second portion is integral with said gasket first portion and is axially wider than said gasket first portion with a shoulder formed at the interface of said gasket first and second portions.

13. The assembly of claim 12 wherein said interface permits said gasket to be centered and retained on one of said flanges during assembly of the joint.

14. The assembly of claim 13 wherein said gasket second portion when uncompressed has an axial dimension that is less than said axial dimension of said groove second portion and serves to stiffen the gasket and maintain a desired alignment of the gasket relative to the flanges during assembly of the joint.

15. The assembly of claim 1 wherein said gasket has a skeleton key-shaped cross-section.

16. The assembly of claim 1 wherein said gasket first portion comprises an O-ring with an inner annular surface, said O-ring annular surface having: a first diameter before the gasket is positioned on one of said flanges, a second diameter that is greater than said first diameter after the gasket is positioned on one of said flanges and before the gasket is compressed.

17. The assembly of claim 2 wherein said radial end walls are formed by rigid radial outer extensions of said flanges that engage independently into mating grooves in the clamp when the joint is assembled to prohibit axial movement of the flanges.

18. The assembly of claim 17 wherein said engagement of flange ends into mating grooves in the clamp when the joint is assembled provides fixed compression of the gasket.

19. The assembly of claim 1 wherein said gasket first portion is axially compressed in the range of about 10%-20% when the joint is assembled, and said gasket second portion is axially compressed in the range of about 5%-15%.

20. The assembly of claim 1 wherein said gasket comprises an elastomer.

21. A sealing gasket for insertion into a circumferentially continuous groove of a flange joint for joining axially aligned tube ends, the flange joint being of the type having axially opposed flanges at the tube ends to form a groove there between when the joint is assembled, the groove being formed by axially opposed seal faces and radial end faces of the flanges, the groove comprising a groove first portion that is open to an interior flow passage of said tubes and a groove second portion that extends radially outward from said groove first portion, with said groove second portion being radially bounded by radial end walls; the gasket comprising:
A gasket first portion for sealing said groove first portion and a gasket second portion that extends from said gasket first portion and into said groove second portion; said gasket first portion comprises an O-ring that is axially compressed when the joint is assembled, said O-ring when under compression in the assembled joint being radially displaced to form a substantially flush seal that is contiguous with interior surfaces of the tubes and comprises internal angles relative to the flanges of greater than 90 degrees within the product-contact zone.

22. The gasket of claim 21 wherein said radial compression opposes radial pressure from fluid in the flow passage to prevent radial displacement of said gasket.

23. The gasket of claim 22 wherein said radial compression effectively increases hoop strength of said gasket.

24. The gasket of claim 23 wherein said expansion space is formed between the opposed flange faces and said clamp cross section.

25. The gasket of claim 24 wherein said gasket comprises an elastomer material.

26. The gasket of claim 25 wherein said gasket has a symmetrical cross sectional shape.

27. The gasket of claim 26 wherein said radial compression of the gasket provides a barrier to atmosphere.

28. The gasket of claim 27 wherein the groove first portion is axially narrower than the groove second portion to form a shoulder at the radial interface thereof, said gasket being sized to have an interference fit with said shoulder to retain the gasket in position when the joint is assembled.

29. The gasket of claim 28 wherein said gasket second portion when uncompressed has an axial dimension that is less than an axial dimension of said groove second portion and has sufficient mass to stiffen the gasket and maintain a desired alignment of the gasket relative to the flanges during assembly of the joint.

30. A method for sealing a flange joint comprising an opposed pair of flanges configured to join axially aligned tube ends, the flanges when the joint is assembled forming a groove there between with the groove being defined by axially opposed seal faces and a radial end face, the method comprising the acts of:
positioning a polymeric gasket in a first and second portion of the groove between axially opposed seal faces of the flanges with said groove second portion being radially bounded by said radial end walls;
compressing the gasket axially when the joint is assembled to displace a portion of the gasket that radially engages the radial end face;
axially compressing an O-ring of said gasket in the groove first portion so that said O-ring is radially displaced to form a seal that is substantially flush with interior surfaces of the tubes; and
compressing the gasket axially when the joint is assembled.

31. The method of claim 30 wherein said radial compression increases an effective hoop strength of the gasket, thereby improving the gasket's capacity to oppose radial forces exerted on the gasket by fluid pressure in the tubes.

32. The method of claim 31 wherein said radial compression provides a secondary seal radially aligned and spaced from a primary seal at an interface of the tube ends.

33. The method of claim 32 further comprising the act of using an interference fit between the gasket and the flanges to retain the gasket in a desired centered position during assembly of the joint.

34. The method of claim 33 further comprising the act of providing sufficient mass to the gasket to maintain a desired alignment of the gasket with respect to the flanges during assembly of the joint.

35. A flange joint and gasket for joining and sealing first and second tube or pipe ends that each define an axial flow passage therethrough, comprising:
a first annular flange and a second annular flange, each of said flanges being at a respective one of the tube ends; said flanges having axially opposed end faces and adjacent radial end walls that define a circumferential groove when the joint is assembled; said groove having a first portion open to the flow passage of the tubes and having a second portion that extends radially outward from said groove first portion, said groove second portion being radially defined by said radial end walls; and
a gasket configured to seal the assembled joint to prevent loss of fluid from the flow passage of the tubes, said gasket having a gasket first portion that seals said groove first portion and having a gasket second portion that extends from said gasket first portion and into said groove second portion; wherein said gasket second portion is axially wider than said gasket first portion and has a cross-section that extends radially outward from said gasket first portion; said gasket second portion being axially compressed when the joint is assembled and engaging with said radial end walls to produce a radial compression of said gasket; said gasket second portion having a volume that is less than volume of said groove second portion to provide an expansion space in said groove second portion when the joint is assembled.
